(19) United States
(12) Patent Application Publication
(10) Pub. No.: US 2026/0330797 A1
(43) Pub. Date: Oct. 22, 2026

(54) SYSTEMS AND METHODS FOR MULTI-MODAL AFFECTED AREA ANALYSIS WITH AUTOMATED VENDOR INTEGRATION

(71) Applicant: Josh ENGLAND, Portland, TN (US)

(72) Inventor: Josh ENGLAND, Portland, TN (US)

(21) Appl. No.: 19/646,039

(22) Filed: Apr. 13, 2026

Related U.S. Application Data
(60) Provisional application No. 63/792,007, filed on Apr. 21, 2025.

(51) Int. Cl. G06V 10/25; G01S 17/86; G01S 17/89; G06T 7/10; G06T 7/50; G06V 10/764

(52) U.S. Cl. CPC G06V 10/25; G01S 17/86; G01S 17/89; G06T 7/10; G06T 7/50; G06V 10/764; G06V 2201/07

(57) ABSTRACT

A system and method for automated analysis of affected areas in photographic data integrates multiple data modalities including three-dimensional Lidar sensing, thermal imaging, and photographic imaging with artificial intelligence-based image segmentation and object detection algorithms. An automated segmentation module preprocesses wide field-of-view images to extract focused regions of interest, reducing computational requirements and enabling object detection processing times of approximately 1-5 seconds per segmented portion. Detected objects are precisely measured through integration with Lidar point cloud data. An API integration module establishes authenticated connections with external vendor database systems, automatically formulates and transmits API requests based on detected object parameters, receives current pricing information in real-time, and aggregates responses from multiple vendors to provide comparative pricing data. Comprehensive reports combine technical analysis results with current market-based cost estimates. The system provides rapid, accurate, and automated assessment capabilities with real-time vendor pricing integration applicable to property inspection, insurance claim processing, disaster response, and infrastructure monitoring industries.

### CROSS-REFERENCE TO RELATED APPLICATIONS

This application claims the benefit of priority under 35 U.S.C. § 119(e) to U.S. Provisional Patent Application No. 63/792,007, filed Apr. 21, 2025, entitled “SYSTEMS AND METHOD FOR CAPTURING AND ANALYZING AFFECTED AREAS IN PHOTOGRAPHIC OR PHOTOGRAMMETRIC DATA,” the entire disclosure of which is incorporated herein by reference.

### FIELD OF THE INVENTION

The present invention relates generally to systems and methods for capturing, analyzing, and measuring affected areas in photographic or photogrammetric data. More particularly, the invention relates to an integrated platform that combines three-dimensional light detection and ranging (Lidar) technology, thermal imaging, artificial intelligence-based image segmentation and object recognition, and real-time application programming interface (API) connections to external vendor database systems to enable automated identification, measurement, and dynamic cost estimation of objects within affected areas.

### BACKGROUND

In various industries including disaster management, insurance claim assessment, property inspection, construction, agriculture, and environmental monitoring, there exists a critical need to accurately identify, measure, and document affected areas captured in photographic or photogrammetric data. Traditional approaches to analyzing such data suffer from significant limitations including manual measurement inaccuracies, time-consuming analysis processes, and lack of integration between different data modalities.

Existing systems for analyzing affected areas typically operate in isolation, requiring separate tools for thermal imaging analysis, three-dimensional spatial measurements, object identification, and cost estimation. A technician might use thermal imaging equipment to identify temperature anomalies, separate Lidar equipment to obtain spatial measurements, manual or semi-automated methods to identify objects of interest, and yet another system to estimate repair or replacement costs. This fragmented approach is inefficient, prone to errors in data transfer between systems, and fails to leverage the synergistic benefits of integrating these complementary data sources.

Furthermore, conventional object recognition approaches applied to wide field-of-view imagery, such as 360-degree panoramic photographs, suffer from substantial computational inefficiencies. Processing entire high-resolution panoramic images through object detection algorithms requires significant computational resources and time, often taking minutes per image even with modern graphics processing units (GPUs). This computational burden makes real-time or near-real-time analysis impractical for many applications.

The advent of advanced machine learning models for image segmentation and object detection has created new opportunities for automation. However, these models are typically designed for standard field-of-view images rather than panoramic data, and their effective integration with other data modalities such as Lidar and thermal imaging remains a technical challenge. Additionally, while these models can identify objects, they do not inherently provide the three-dimensional measurements or cost estimation capabilities required for practical applications in property assessment and disaster management.

Another significant limitation of existing systems is the disconnection between technical analysis and practical business needs. Even when objects are successfully identified and measured, determining the associated costs for repair, replacement, or remediation typically requires separate manual processes involving contacting vendors, obtaining quotes, and aggregating pricing information. This manual cost estimation process introduces delays, inconsistencies, and potential errors that reduce the overall efficiency and reliability of the assessment workflow.

Some conventional systems have attempted to address cost estimation through stored historical repair data or predictive models trained on past costs. While such approaches avoid external dependencies, they suffer from inherent accuracy limitations as market conditions diverge from historical trends and cannot provide current comparative vendor pricing. Real-time integration with external vendor systems introduces distinct technical challenges including establishing authenticated connections with heterogeneous vendor APIs, implementing rate limiting, handling service unavailability, and aggregating responses from multiple vendors, all of which are challenges not addressed by systems relying on static historical data.

What is needed is an integrated system that combines multiple data modalities, including Lidar, thermal imaging, and photographic data, with advanced artificial intelligence algorithms and real-time external vendor system integration to provide rapid, accurate, and comprehensive analysis of affected areas with current market-based cost information and minimal manual intervention.

### SUMMARY OF THE INVENTION

In accordance with certain aspects of an embodiment of the invention, an integrated multi-modal platform is provided for automated identification, measurement, and real-time cost estimation of affected areas in photographic or photogrammetric data. The invention combines hardware components including precision Lidar sensors and thermal imaging cameras with software components including artificial intelligence-based image segmentation and object detection modules, three-dimensional measurement algorithms, and real-time application programming interface (API) connections to external vendor database systems to enable end-to-end automation of the affected area analysis workflow with current pricing information.

In one aspect, an embodiment of the invention provides a system for analyzing affected areas comprising an image capture device configured to acquire photographic images and three-dimensional point cloud data of an area of interest, wherein the image capture device includes an integrated Lidar sensor and a field of view of preferably at least 350 degrees. A thermal imaging module captures temperature data substantially simultaneously with the photographic images and generates thermal overlay data indicating temperature variations within the captured scene. An automated segmentation module processes the photographic images using a machine learning-based segmentation model to identify regions of interest and generate segmented image portions, thereby reducing computational requirements for subsequent object detection processing. An object recognition module applies a real-time object detection model to the segmented image portions to identify and classify objects within the affected areas. A spatial measurement module integrates the three-dimensional point cloud data with the identified objects to generate precise measurements including dimensions, areas, and volumes.

An API integration module establishes and maintains authenticated network communication channels with one or more external vendor database systems, automatically formulates and transmits API requests based on the detected objects to query vendor systems for current pricing information, receives pricing responses in real-time, aggregates pricing information from multiple vendor systems to generate comparative pricing data, and implements intelligent caching strategies to optimize API usage. This real-time vendor integration may offer improvements over conventional systems that rely on stored historical pricing data or predictive cost models, as it provides users with current market pricing that reflects real-time vendor availability, regional pricing variations, and current market conditions. An output module provides the identification, measurement, and current vendor pricing data for use in generating comprehensive assessment reports or other outputs.

The automated segmentation module preferably implements a promptable segmentation model such as the Segment Anything Model (SAM) or similar zero-shot segmentation architecture to process wide field-of-view images and automatically extract focused regions of interest without requiring task-specific training data. This segmentation preprocessing step, referred to herein as “chipping,” dramatically reduces the computational load on downstream object detection algorithms by extracting smaller, focused image segments from large panoramic source images. This preprocessing approach differs fundamentally from conventional segmentation systems that perform segmentation as an end goal for object identification rather than as a preprocessing step to reduce computational requirements for subsequent object detection.

The invention further provides methods for real-time or near-real-time processing of simultaneous data streams from multiple image capture devices or user uploads. A queue-based architecture receives incoming data, distributes processing tasks across multiple worker processes, and implements optimization techniques including batching, concurrent task execution, and asynchronous I/O operations to maximize throughput and minimize latency. The system architecture supports horizontal scaling to accommodate increased data volumes by deploying additional processing instances behind load balancers.

In another aspect, an embodiment of the invention provides methods for thermal-guided automated affected area detection. The system analyzes thermal imaging data to identify temperature anomalies exceeding predefined thresholds and automatically generates affected area boundaries corresponding to these thermal anomalies. This automated approach eliminates manual outline drawing while providing objective, reproducible affected area definitions based on quantitative thermal data. The thermal-identified affected areas can then be queried against vendor systems for remediation pricing specific to the type and extent of thermal anomalies detected.

The invention preferably integrates multiple open-source and proprietary machine learning models within a novel processing pipeline that provides technical improvements beyond the capabilities of the individual models. While the Segment Anything Model and YOLO (You Only Look Once) family of object detection models are publicly available, the invention's specific integration of these models with Lidar spatial data, thermal imaging, and real-time automated vendor cost estimation through authenticated API connections represents a novel technical solution to the problem of comprehensive affected area analysis with current pricing information.

Advantageously, the invention provides automated analysis with minimal manual intervention, precise measurements through Lidar integration, rapid processing through intelligent image segmentation preprocessing, real-time cost estimation reflecting current market conditions through vendor API integration, and comprehensive reporting that combines technical analysis with business-relevant current pricing information. The system finds applications across diverse industries including insurance claim assessment, disaster response, property inspection, agricultural monitoring, and infrastructure assessment.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a system architecture diagram illustrating the major hardware and software components of an affected area analysis system according to certain aspects of an embodiment of the invention.

FIG. 2 is a flowchart illustrating the automated image processing pipeline according to further aspects of an embodiment of the invention.

FIG. 3 is a detailed block diagram of an API integration module for use in the system of FIG. 1.

FIG. 4 is a data flow diagram according to further aspects of an embodiment of the invention illustrating integration of Lidar point cloud data with two-dimensional photographic images to create depth-mapped images with assigned pixel depth values.

FIG. 5 is an illustration showing an example 360-degree panoramic image and multiple segmented image portions extracted therefrom by an automated segmentation module according to further aspects of an embodiment of the invention.

FIG. 6 is a block diagram of a queue-based processing architecture for handling simultaneous data streams according to further aspects of an embodiment of the invention.

FIG. 7 is a schematic diagram showing a thermal imaging overlay process according to further aspects of an embodiment of the invention.

FIG. 8 is a flowchart illustrating an API vendor query process according to further aspects of an embodiment of the invention.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

In accordance with certain aspects of an exemplary embodiment, systems and methods are provided for comprehensive analysis of affected areas in photographic or photogrammetric data through integration of multiple data modalities and automated processing techniques with real-time external vendor system connectivity.

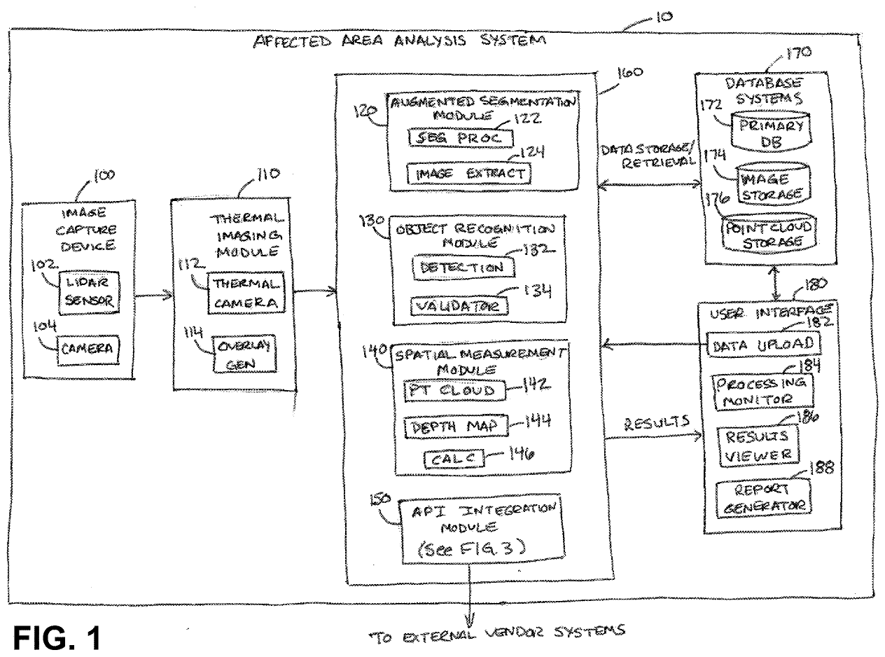

Referring now to FIG. 1, there is shown a system architecture diagram of an affected area analysis system 10 according to one embodiment of the invention. The system 10 comprises several interconnected modules and components that work in concert to provide automated identification, measurement, and real-time cost estimation of affected areas.

The image capture device 100 serves as the primary data acquisition component. In the preferred embodiment, the image capture device 100 comprises an integrated sensor assembly that includes both a precision Lidar sensor 102 and a photographic camera 104. The Lidar sensor 102 is configured to capture three-dimensional point cloud data representing the spatial geometry of the environment. The Lidar sensor 102 preferably has a minimum accuracy specification of approximately plus or minus one inch (±2.5 centimeters), which provides sufficient precision for detailed spatial measurements required in property assessment and damage evaluation applications. The field of view of the Lidar sensor 102 is preferably at least 350 degrees, enabling comprehensive spatial data capture with minimal blind spots. The operational range of the Lidar sensor 102 is preferably between approximately 100 feet (30 meters) and 160 feet (50 meters), which accommodates typical room dimensions and outdoor assessment scenarios.

The photographic camera 104 is integrated with the Lidar sensor 102 to enable simultaneous or substantially simultaneous capture of two-dimensional photographic images and three-dimensional point cloud data. This integration facilitates accurate synchronization and alignment between the two data modalities. The photographic camera 104 preferably has a wide field of view, such as a 360-degree panoramic camera, to capture comprehensive visual information of the assessment area. Images are preferably captured in PNG (Portable Network Graphics) format to provide lossless image quality that preserves fine details necessary for accurate object detection and measurement.

The thermal imaging module 110 comprises a thermal camera 112 or infrared imaging sensor configured to capture temperature data of the scene. The thermal imaging module 110 operates to detect temperature variations and anomalies that may indicate affected areas such as water intrusion, insulation deficiencies, electrical hotspots, or other temperature-related issues. The thermal imaging module 110 may be integrated into the same physical housing as the image capture device 100 or may comprise a separate unit that captures thermal data substantially simultaneously with the photographic and Lidar data acquisition. A thermal overlay generator 114 processes the captured thermal data to generate overlay representations that can be superimposed on the photographic images to provide visual indication of temperature variations.

The automated segmentation module 120 receives the captured photographic images from the image capture device 100 and processes these images using machine learning-based segmentation algorithms to identify regions of interest. The automated segmentation module 120 preferably implements a large-scale segmentation model such as the Segment Anything Model (SAM) developed by Meta AI Research or similar promptable segmentation architectures. SAM provides zero-shot segmentation capability, meaning it can accurately segment diverse objects without requiring task-specific training data. The automated segmentation module 120 operates to identify discrete objects, surfaces, and regions within the source images and to extract these identified regions as separate segmented image portions. This process, referred to herein as “chipping,” substantially reduces the computational requirements for subsequent object detection by producing smaller, focused images rather than requiring the object detection algorithms to process entire high-resolution panoramic images. This preprocessing segmentation enables rapid processing of each extracted segment, with typical object detection times of approximately 1-5 seconds per segment compared to minutes for processing full panoramic images.

A segmentation processor 122 within the automated segmentation module 120 executes the segmentation algorithms, which may run on dedicated graphics processing unit (GPU) hardware for accelerated processing. An image extraction component 124 extracts the identified regions from the source image to produce the segmented image portions, preferably including appropriate context margins around identified objects to ensure complete object capture.

The object recognition module 130 receives the segmented image portions from the automated segmentation module 120 and applies real-time object detection and classification algorithms to identify specific objects of interest and assign classification labels. The object recognition module 130 preferably implements one or more variants of the YOLO (You Only Look Once) family of object detection models, such as YOLOv8, YOLOv11, or other optimized versions available from Ultralytics or similar providers. YOLO models are particularly well-suited for this application due to their high inference speed and accuracy. The object recognition module 130 processes each segmented image portion to detect and classify objects according to predefined categories relevant to the application domain.

For property assessment applications, the classification categories preferably include architectural features such as windows, doors, walls, roofs, stairs, and fireplaces; appliances such as ovens, refrigerators, dishwashers, washing machines, and dryers; fixtures such as sinks, toilets, showers, bathtubs, and light fixtures; room types such as kitchen, living room, bedroom, and bathroom; structural elements such as beams and columns; and potential damage or anomalies such as cracks, leaks, stains, and mold. The specific categories can be customized based on the target application and the training data used to train or fine-tune the object detection models.

An object detection processor 132 executes the object detection algorithms, generating bounding boxes around detected objects and assigning classification labels with associated confidence scores. A classification validator 134 filters detection results based on confidence thresholds to exclude low-confidence detections that may represent false positives.

The spatial measurement module 140 integrates the three-dimensional Lidar point cloud data with the detected objects to generate precise spatial measurements. The Lidar point cloud data comprises a collection of three-dimensional coordinate points representing surfaces within the captured scene. A point cloud processor 142 receives Lidar data preferably in LAS (Lidar Data Exchange Format) or LAZ (compressed LAS) industry-standard formats and performs preprocessing operations including noise filtering, outlier removal, and coordinate system alignment.

A depth mapping component 144 creates depth chart overlays by associating depth values from the point cloud data with corresponding pixels in the two-dimensional photographic images. This depth mapping process enables three-dimensional spatial information to be visualized and analyzed in the context of the photographic images. The depth mapping relies on calibrated transformation matrices that account for the relative positioning and orientation of the Lidar sensor 102 and photographic camera 104 within the integrated image capture device 100.

A measurement calculator 146 computes various spatial measurements for the detected objects based on the integrated depth information. For area measurements of affected regions such as damaged surfaces, the measurement calculator 146 analyzes the segmentation masks in conjunction with depth data to determine surface areas, preferably with a target accuracy of approximately ±0.5 inches. For fixed point measurements such as distances between structural features, the measurement calculator 146 determines distances between identified three-dimensional coordinate points, preferably with a target accuracy of approximately ±1 inch, consistent with the Lidar sensor accuracy specification. The measurement calculator 146 can compute various measurement types including linear distances, surface areas, perimeters, and volumes as appropriate for the detected object types. Measurements are preferably output in multiple standard units including millimeters, centimeters, meters, inches, feet, square meters, square feet, and cubic measurements as appropriate.

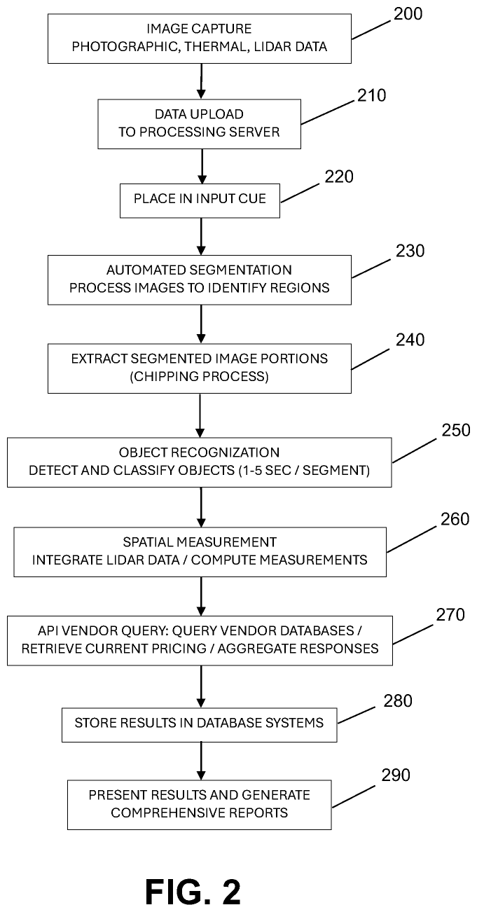

The modules described above operate in conjunction with a processing server 160, database systems 170, and user interface 180, each of which is described in detail below. With the principal components of the system 10 having been introduced, attention is directed to the overall image processing pipeline, illustrated in FIG. 2, through which these components operate in concert to achieve automated affected area analysis.

Referring now to FIG. 2, there is shown a flowchart illustrating the automated image processing pipeline according to one embodiment of the invention. The process begins at step 200 with image capture, wherein the image capture device 100 acquires photographic images, thermal imaging data, and Lidar point cloud data of the area to be assessed. The data capture is preferably performed with synchronized timing to ensure temporal alignment between the different data modalities.

At step 210, the captured data is uploaded to the processing server 160 via the user interface 180. For field operations where internet connectivity may be limited, the data may be temporarily stored locally on the image capture device 100 or associated mobile device and uploaded when connectivity is available. The upload process includes data validation checks to verify file integrity, format compliance, and completeness of the dataset.

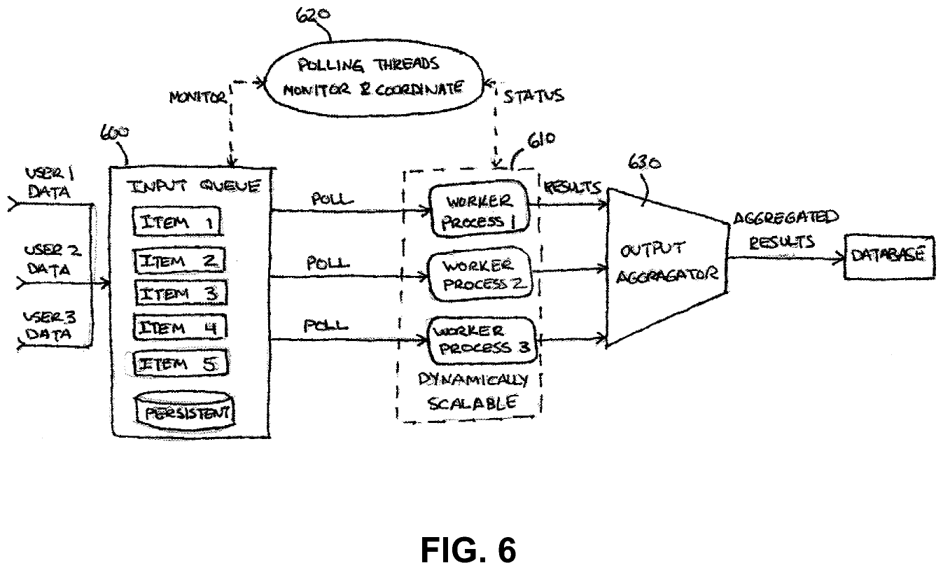

At step 220, the uploaded data is placed into an input queue for processing. The queue-based architecture, described in greater detail below with reference to FIG. 6, enables efficient handling of multiple concurrent data uploads and balances the processing load across available computational resources.

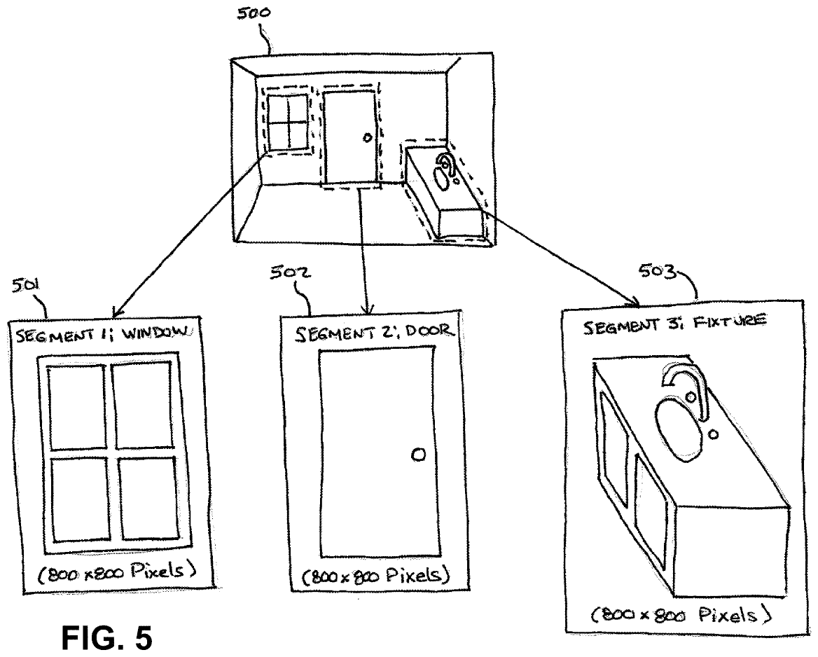

At step 230, the automated segmentation module 120 processes the photographic images to identify and extract regions of interest. For a 360-degree panoramic image 500 as shown in FIG. 5, the segmentation process identifies multiple discrete objects, surfaces, and regions within the panorama. The segmentation algorithm operates by analyzing the image at multiple scales and identifying boundaries between distinct objects based on visual features such as color, texture, edges, and semantic content. The promptable segmentation model can operate without explicit prompts to generate comprehensive segmentation of all identifiable objects, or can accept prompts such as point coordinates or bounding box hints to focus segmentation on specific areas of interest when thermal imaging has identified affected areas requiring detailed analysis.

At step 240, segmented image portions 501, 502, 503 are extracted from the source panoramic image 500 as illustrated in FIG. 5. Each segmented image portion comprises a cropped region containing one or more detected objects along with appropriate context margins. The extraction process records the spatial relationship between each segmented portion and the source image coordinates to enable subsequent registration of detection results back to the source image. This “chipping” process dramatically reduces the computational requirements for subsequent object detection by enabling the object detection algorithms to process focused image segments rather than the entire panoramic image. For example, a 360-degree panoramic image may have dimensions of 8000×4000 pixels, while extracted segments may be 800×800 pixels, representing a substantial reduction in data volume per segment.

At step 250, the object recognition module 130 processes each segmented image portion using real-time object detection algorithms. The YOLO-based object detection models analyze each image segment to detect objects of interest, determine bounding box coordinates around each detected object within the segment coordinate system, assign classification labels from the predefined category set, and generate confidence scores indicating the model's certainty in each detection and classification.

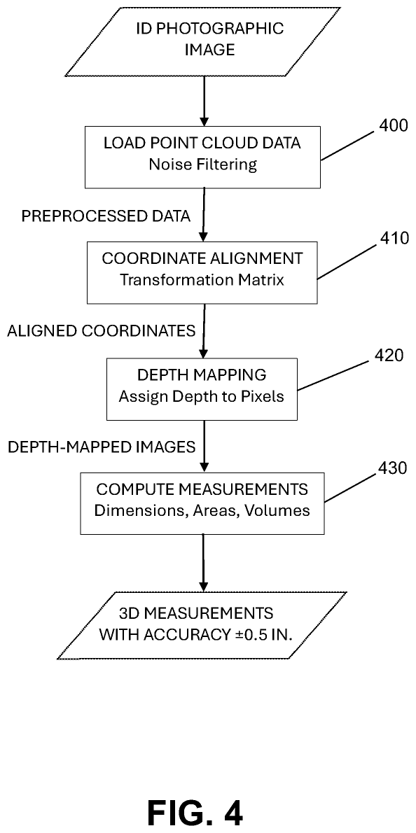

At step 260, the spatial measurement module 140 integrates the Lidar point cloud data with the detected objects to generate precise three-dimensional measurements. Referring to FIG. 4, this integration process involves several sub-steps. First, at substep 400, the Lidar point cloud data is loaded and preprocessed to remove noise and outliers using statistical filtering techniques. At substep 410, the coordinate system of the point cloud is aligned with the coordinate system of the photographic images using calibrated transformation matrices that account for the relative positioning and orientation of the Lidar sensor 102 and camera 104. At substep 420, depth values from the point cloud are assigned to corresponding pixels in the two-dimensional images, creating depth-mapped images where each pixel has an associated depth value. At substep 430, for each detected object, the associated depth values within the object's bounding box or segmentation mask are analyzed to compute spatial measurements such as dimensions, surface areas, and volumes.

With continuing reference to FIG. 2, at step 270, the API integration module 150 queries vendor database systems based on the detected objects and their measurements to retrieve current pricing information. For each detected object of a type that may require repair or replacement, the pricing query engine 154, described in greater detail below, formulates appropriate API requests including parameters such as object type, dimensions, materials, location, and quantity. The API requests are transmitted to one or more vendor systems using the authenticated connection channels established by the API connection manager 151, also described in greater detail below. The requests are processed asynchronously to enable concurrent querying of multiple vendors. As vendor responses are received, response aggregator 155 compiles and standardizes the pricing information. When multiple vendors provide pricing for similar items, comparative information is generated showing price ranges, average pricing, and vendor-specific details to assist users in making informed decisions.

At step 280, the aggregated results including detected objects, classifications, measurements, and current vendor pricing information are stored in the database systems 170. The results are indexed and organized to enable efficient retrieval and querying.

At step 290, the results are presented to the user through the user interface 180, and comprehensive reports are generated according to user specifications or predefined templates. The reports combine technical analysis results with business-relevant cost information to provide actionable insights for property assessment, insurance claim processing, or disaster response planning.

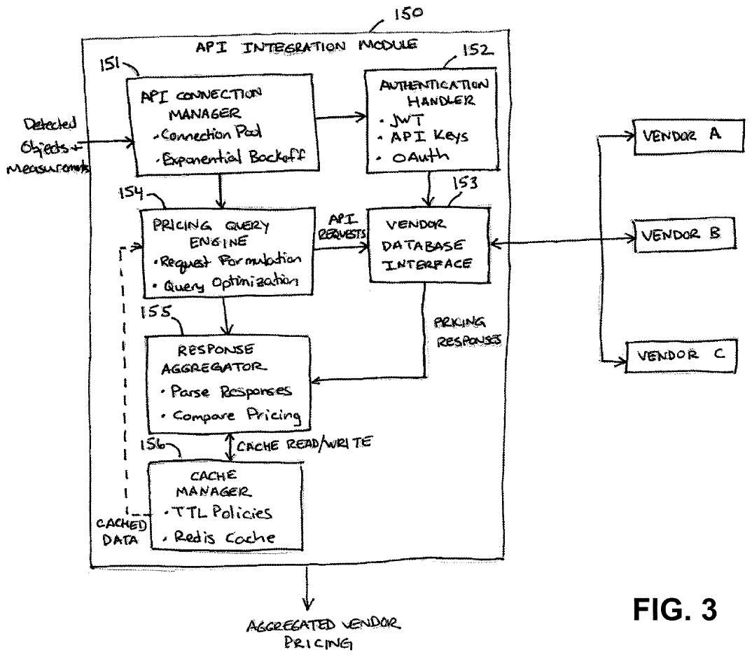

Having established the end-to-end processing workflow, attention is now directed to the API integration module 150 in greater detail with reference to FIG. 3, which module bridges technical object identification with real-time current market pricing information.

The API integration module 150, shown in detail in FIG. 3, provides real-time automated connectivity to external vendor database systems to enable current cost estimation based on the detected objects and associated measurements. The API integration module 150 bridges the gap between technical object identification and practical business needs by automatically obtaining current market pricing information without manual intervention.

Referring to FIG. 3, the API integration module 150 comprises several subcomponents that work together to provide secure, reliable, and efficient vendor data integration. An API connection manager 151 establishes and maintains persistent or on-demand connection channels with one or more vendor database systems. The connection manager 151 implements connection pooling, wherein a set of pre-established network connections is maintained and reused for multiple API requests rather than creating new connections for each request. Connection pooling significantly reduces connection establishment overhead, which can be substantial when using secure protocols such as HTTPS with TLS/SSL handshaking. The connection pool is dynamically sized based on system load and vendor responsiveness.

The connection manager 151 also implements reconnection logic with exponential backoff algorithms to handle temporary network disruptions or vendor service unavailability. When an API request fails due to network error or timeout, the connection manager waits for an initial delay period before retrying. If subsequent retries fail, the delay period is exponentially increased up to a maximum delay threshold. This exponential backoff prevents the system from overwhelming recovering vendor services with rapid repeated requests while ensuring eventual successful connection when services are restored.

An authentication handler 152 manages the security credentials and authentication protocols required to access vendor APIs. The authentication handler 152 preferably implements industry-standard authentication mechanisms including JSON Web Tokens (JWT), API keys, OAuth 2.0, or other secure authentication protocols as required by the specific vendor systems. JSON Web Tokens are compact, URL-safe tokens containing encoded claims that are digitally signed to verify authenticity. When using JWT authentication, the authentication handler 152 stores the token, includes it in the HTTP Authorization header of API requests using the Bearer scheme, monitors token expiration times, and automatically requests token refresh before expiration to maintain uninterrupted service. API key authentication involves including a unique key string in API requests, typically in an HTTP header or as a query parameter. The authentication handler 152 securely stores API keys, preferably using encrypted storage mechanisms, and ensures that all API communications include proper authentication information. The system implements role-based access control (RBAC) to ensure that only authorized users and processes can access vendor pricing data.

A vendor database interface 153 provides abstraction layers for communicating with diverse vendor systems that may implement different API specifications, data formats, and communication protocols. The vendor database interface 153 implements vendor-specific adapter patterns that translate between the system's internal data representations and the vendor-specific formats. This abstraction enables the system to integrate with multiple vendors without requiring changes to the core processing logic.

Each vendor adapter encapsulates the specific requirements of a particular vendor's API, including endpoint URL structures, required and optional parameters, request header requirements, response data schemas, and error response formats. The interface preferably supports RESTful API architectures communicating via HTTP/HTTPS protocols with JSON data formatting. Representational State Transfer (REST) is an architectural style for distributed systems that uses standard HTTP methods to perform operations on resources identified by URLs. JSON (JavaScript Object Notation) is a lightweight text-based data interchange format that is human-readable and widely supported. Though REST and JSON are preferred, the modular adapter architecture can accommodate other protocols such as SOAP, GraphQL, or proprietary protocols through appropriate adapter implementations.

A pricing query engine 154 formulates and executes queries to vendor database systems based on the detected objects and their attributes. When an object such as a window, appliance, or structural element is detected and measured, the pricing query engine 154 generates appropriate API requests to query vendor databases for current pricing information for repair, replacement, or remediation of the detected item.

The query formulation process involves several steps. First, the detected object classification and measurements are analyzed to extract relevant parameters for the vendor query. For example, for a detected window, relevant parameters might include window type, dimensions, frame material (if determinable from image analysis), and glass type. Second, these parameters are mapped to the specific parameter names and formats required by each vendor's API specification using the vendor-specific adapters. Third, additional parameters such as geographic location and quantity are added. Fourth, the complete API request is constructed according to the vendor's specification, including proper authentication credentials, required headers, and payload formatting.

The pricing query engine 154 implements intelligent query optimization to minimize API call volume and reduce costs. Query optimization techniques include batch processing when vendor APIs support multiple items in a single call, similarity detection to avoid redundant queries for similar items, selective querying based on user preferences or configuration, and cached data utilization by checking the cache manager 156 before issuing API requests.

The pricing query engine 154 implements asynchronous request processing to enable concurrent queries to multiple vendor systems. Rather than sequentially querying each vendor and waiting for responses, the engine submits requests to all relevant vendors concurrently and processes responses as they arrive. This parallel processing approach significantly reduces total query time when multiple vendors are involved.

A response aggregator 155 receives pricing responses from one or more vendor API calls and aggregates this information into a unified format for presentation to users. Vendor API responses typically include information such as item descriptions, unit costs, quantity-based pricing tiers, estimated lead times, vendor contact information, and any applicable terms or conditions. The response aggregator 155 parses these vendor-specific responses and converts them into a standardized internal format.

When multiple vendors provide pricing for similar items, the response aggregator 155 compiles pricing from multiple vendors and presents comparative information showing preferably price ranges, average prices, lowest and highest prices, and vendor-specific details. This enables users to make informed decisions about which vendors to engage. The aggregator may identify and flag pricing that significantly deviates from the median or average, which may indicate data errors, special circumstances, or particularly favorable or unfavorable pricing. The aggregator integrates information about, for example, vendor availability, lead times, and stock status when provided by vendor APIs, enabling users to consider not just price but also availability in their decisions.

The response aggregator 155 also implements comprehensive error handling logic to handle situations where one or more vendor APIs fail to respond or return error conditions. Error scenarios include network timeouts, HTTP error status codes, authentication failures, rate limit exceeded responses, malformed response data, and missing required fields in responses. When partial failures occur, the aggregator ensures that successfully retrieved pricing information is still presented to users along with clear indication of which vendors failed to respond and why.

A cache manager 156 implements intelligent caching of vendor pricing responses to reduce redundant API calls, minimize costs, and improve system responsiveness. The cache manager 156 preferably implements a distributed cache using technologies such as Redis, an in-memory data structure store that provides high-performance key-value caching with support for data persistence and distributed deployment. Redis enables cache sharing across multiple processing instances in scaled deployments, ensuring that all system components benefit from cached data regardless of which specific processing server handled previous requests.

The caching system uses a hierarchical key structure to organize cached data. Cache keys are constructed from relevant parameters such as vendor identifier, item type, dimensions, materials, location, and query timestamp. Cache expiration policies balance the competing goals of reducing API call volume and maintaining data currency. The cache manager 156 implements configurable time-to-live (TTL) values for different types of pricing data. For commodity items with relatively stable pricing, longer TTL values may be appropriate. For specialty items or markets with volatile pricing, shorter TTL values ensure that users receive current pricing information. The cache manager may also implement a “stale-while-revalidate” strategy wherein expired cached data can be served to users immediately while a background process asynchronously fetches updated data from the vendor API. This approach provides optimal user experience by eliminating wait times for API responses while still ensuring that data is periodically refreshed.

The API integration module 150 implements rate limiting functionality to ensure compliance with vendor API usage restrictions and to prevent system behavior from triggering vendor-side rate limiting or service blocking. Vendor APIs may impose rate limits such as “100 requests per minute” or “1000 requests per day per API key.” The rate limiter tracks API call frequency per vendor using sliding window or token bucket algorithms. When approaching rate limits, the system implements throttling by queuing requests for delayed processing or by increasing reliance on cached data. The system provides feedback to users when rate limiting affects data availability.

The API integration module 150 implements comprehensive logging of all API interactions for audit purposes, troubleshooting, and monitoring of vendor API performance and reliability. Logged information includes request timestamps, request parameters, vendor identifiers, response times, HTTP status codes, error conditions and messages, data volumes, cache hit or miss indicators, and authentication events. This logging enables system administrators to identify vendor API issues, optimize API usage patterns, monitor vendor service level agreement compliance, analyze cost drivers for APIs with per-request charges, and troubleshoot integration problems.

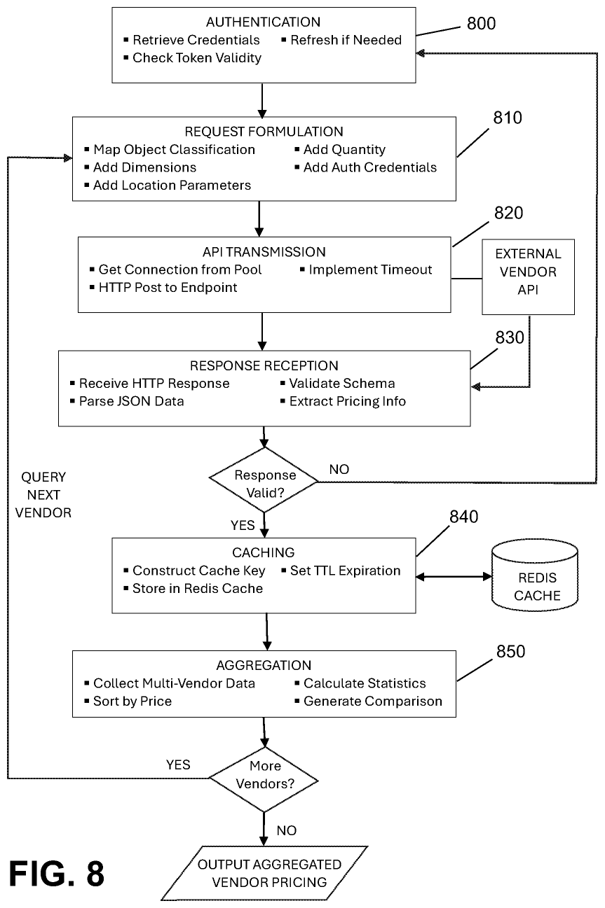

The step-by-step operation of the API integration module 150 during an actual vendor pricing query is illustrated by the flowchart of FIG. 8, which depicts the complete vendor query process from authentication through response aggregation.

More particularly, FIG. 8 shows a flowchart illustrating the API vendor query process according to an embodiment of the invention, which occurs after object detection and measurement to retrieve current vendor pricing.

At step 800, the authentication process begins. The authentication handler 152 retrieves stored credentials for the target vendor, which may include API keys, OAuth tokens, or other authentication information. If using JWT authentication, the handler checks whether the current token is still valid and requests a token refresh if needed. The authentication information is prepared for inclusion in the API request headers.

At step 810, the pricing query engine 154 formulates the API request based on the detected object parameters. The object classification is mapped to the vendor's product category schema. Dimensional measurements are converted to the units required by the vendor API. Material information, if available, is included. Geographic location parameters are added based on the property address. The complete request payload is constructed in the format required by the vendor.

To illustrate the request formulation process, consider a scenario in which the object detection module identifies a double-hung window with measured dimensions of 36 inches wide by 60 inches tall within an assessed property located in zip code 12345. The pricing query engine maps the classification “window” to the corresponding product category in the vendor's schema, converts the measured dimensions to the units required by the vendor API, adds the property zip code as the location parameter, sets the quantity based on the number of similar windows detected, and assembles these parameters into a JSON-formatted HTTP POST request directed to the vendor's pricing endpoint with the appropriate authentication credentials in the request header.

At step 820, the API request is transmitted to the vendor system via HTTP/HTTPS protocols. The connection manager 151 retrieves an available connection from the connection pool or establishes a new connection if needed. The request is submitted as an HTTP POST to the vendor's API endpoint URL with appropriate headers and JSON payload. The system implements timeout handling to prevent indefinite waiting.

At step 830, the vendor API response is received and processed. The response typically includes an HTTP status code and a response body containing pricing data in JSON format. The response aggregator 155 parses the JSON response and extracts relevant pricing information including item descriptions, unit costs, total costs, availability information, and any error messages. Response validation ensures that all expected fields are present and contain valid data types.

At step 840, the cache manager 156 stores the received pricing data in the distributed cache with appropriate cache keys and expiration times. The cache key is constructed from the request parameters to enable future cache lookups for similar queries. The time-to-live value is set based on the vendor-specific configuration and the type of pricing data.

At step 850, when multiple vendor queries have been processed, the response aggregator 155 compiles the pricing data from all vendors into a unified format. The aggregation process includes sorting vendors by price, calculating summary statistics, identifying outliers, and formatting the data for presentation to users. The aggregated data is returned to the output module for presentation to users or inclusion in assessment reports.

The entire API query process from authentication through aggregation typically completes in 1-3 seconds per vendor, enabling users to receive current pricing from multiple vendors within seconds of completing the object detection and measurement analysis.

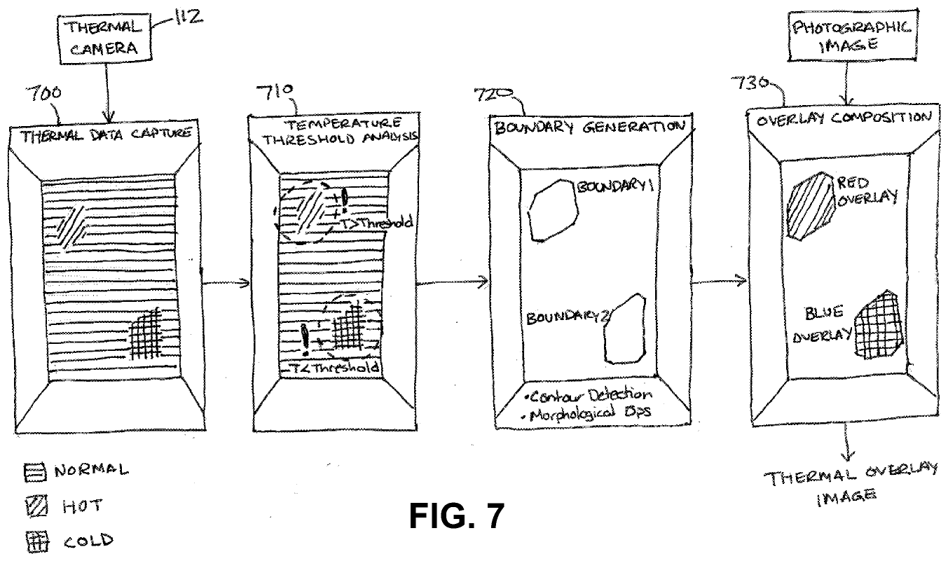

Beyond its image-based processing capabilities, the system incorporates thermal imaging as an additional and independent modality for identifying and delineating affected areas. The thermal-guided affected area detection process is illustrated in FIG. 7 and is described in detail below.

Referring to FIG. 7, at step 700 of the thermal-guided affected area detection process, thermal data capture occurs substantially simultaneously with photographic image capture. The thermal camera 112 captures infrared radiation emitted by surfaces in the scene, and this data is converted into temperature values for each pixel in the thermal image. The thermal image has spatial correspondence with the photographic image, enabling accurate overlay of thermal information on visible light photographs through coordinate transformation and image registration techniques.

At step 710, temperature threshold analysis is performed to identify areas exhibiting temperature anomalies. The system applies predefined or user-configurable temperature thresholds to identify regions where temperatures exceed, fall below, or deviate significantly from expected values. For example, in building assessment applications, areas with unexpectedly low temperatures may indicate insulation deficiencies, air infiltration, or thermal bridging through structural elements. Areas with elevated temperatures may indicate electrical issues, inadequate ventilation, solar heat gain through compromised building envelope components, or active water leaks. Multiple threshold levels can be applied to categorize anomaly severity based on the magnitude of temperature deviation.

At step 720, affected area boundary generation occurs based on the identified temperature anomalies. The system analyzes connected regions of pixels exceeding the temperature thresholds and generates boundary polygons or curves that delineate the extent of each affected area. Image processing techniques including contour detection algorithms identify the boundaries of connected anomalous regions. Morphological operations such as erosion and dilation may be applied to remove noise artifacts, fill small gaps, and smooth boundaries for clearer visualization. Each affected area is assigned attributes including area measurement, severity classification, average temperature and temperature range, and spatial location coordinates.

At step 730, overlay composition combines the affected area boundaries with the photographic images to create visual representations of the thermal analysis. The overlays preferably use color coding to represent different temperature ranges or anomaly types, with color intensity representing severity. Users can toggle the overlay display on and off, adjust transparency levels, and customize visualization parameters. The affected area boundaries generated through thermal analysis can also guide the automated segmentation module 120 to focus segmentation and object detection processing on thermally identified regions of interest.

Once affected areas are identified through thermal analysis, the API integration module 150 can query vendor databases for remediation pricing specific to the type of thermal anomaly detected. For example, areas identified as having low-temperature anomalies indicating insulation deficiencies can trigger queries for insulation installation or improvement services, while high-temperature electrical anomalies can trigger queries for electrical inspection and repair services.

The efficient handling of concurrent data streams produced by the foregoing capture and processing operations is managed by the queue-based processing architecture illustrated in FIG. 6, which enables the system to service multiple simultaneous assessment jobs without bottlenecks.

Referring to FIG. 6, the queue-based processing architecture enables efficient handling of simultaneous data streams from multiple sources. When data uploads or processing requests arrive from multiple users or multiple sites concurrently, the system efficiently distributes the processing workload to avoid bottlenecks and provide responsive service to all users.

At the input queue 600, incoming data items and processing requests are received and buffered. The input queue 600 may be implemented using message queue services such as Redis Queue, RabbitMQ, Apache Kafka, Amazon SQS, or similar technologies. Each item placed in the queue includes the necessary information to perform the requested processing, such as identifiers for uploaded image files and point cloud data, user identification, processing parameters including which vendors to query for pricing, and priority indicators. Message queues provide persistence and acknowledgement mechanisms, ensuring that queued items are stored durably and will not be lost if processing servers restart or experience failures.

Multiple worker processes 610 continuously poll the input queue 600 to retrieve and process pending items. Each worker process 610 operates independently and can execute on the same physical server or on separate servers in a distributed architecture. When a worker process 610 retrieves an item from the queue, it performs the required processing steps including segmentation, object detection, spatial measurement, API vendor queries, and result aggregation. The number of active worker processes 610 can be dynamically scaled based on queue depth and system load. Auto-scaling policies can be configured such as “spawn additional worker process when queue depth exceeds 50 items.”

Polling threads 620 provide monitoring and coordination functions. Polling threads periodically check the status of processing jobs by querying the database systems 170 (FIG. 1) for job status records. Status information is updated in real-time as worker processes complete processing stages, and these updates are propagated to the user interface 180. Polling threads also implement health check functions to verify that worker processes 610 are functioning correctly. If worker failures are detected, the polling threads can initiate restart or recovery procedures.

The output aggregator 630 collects completed processing results from the worker processes 610 and performs final assembly and formatting operations. For assessment jobs that involve processing multiple images or multiple sites, the output aggregator 630 combines the individual results into cohesive report packages. This queue-based architecture provides load balancing across available computational resources, fault tolerance through job persistence and retry mechanisms, scalability through dynamic worker process scaling, and orderly processing of concurrent requests.

Referring again to FIG. 1, the processing and storage infrastructure underlying the foregoing capabilities comprises the processing server 160 and associated database systems 170.

The processing server 160 provides the computational infrastructure for executing the various processing modules. The processing server 160 preferably comprises one or more high-performance server computers equipped with substantial computational resources. For the machine learning-based processing tasks including image segmentation and object detection, the processing server 160 includes one or more NVIDIA graphics processing units (GPUs) with CUDA version 11.2 or later to enable GPU-accelerated processing. Each GPU preferably has at least 12 gigabytes of video RAM (VRAM) to accommodate large models and batch processing. The processing server 160 also includes high-performance multi-core central processing units (CPUs), substantial system random access memory (RAM) preferably exceeding 64 gigabytes, and high-speed solid-state storage for the operating system, software, and frequently accessed data.

The database systems 170 provide persistent storage for various categories of data generated and processed by the system. A primary database 172, preferably implemented using MongoDB or similar document-oriented database systems, stores structured data including assessment records, object detection results, classification labels, measurements, user information, vendor query history, pricing data, and metadata. The document-oriented architecture of MongoDB is particularly well-suited for storing the diverse and hierarchical data structures generated during affected area analysis, including nested objects representing detection results, measurements, and vendor pricing responses.

An image storage system 174 provides scalable storage for photographic images, segmented image portions, thermal overlays, and processed result images with annotations. The image storage system 174 may be implemented using cloud-based object storage services such as Amazon S3, Google Cloud Storage, or Microsoft Azure Blob Storage, or using self-hosted object storage solutions such as MinIO.

A point cloud storage system 176 provides storage for the three-dimensional Lidar point cloud data in LAS, LAZ, PCD, or PLY formats. Given the substantial storage requirements for high-density point cloud data, the point cloud storage system 176 preferably implements data compression and may utilize tiered storage architectures that migrate less frequently accessed data to lower-cost storage media while maintaining frequently accessed data on high-performance storage.

User access to the system's processing and analysis capabilities is provided through the user interface 180, which enables users to upload captured data, monitor processing progress, review results, and generate reports.

The user interface 180 is preferably implemented as a web-based application accessible through standard web browsers, enabling cross-platform compatibility without requiring installation of specialized client software. Alternatively, native applications for mobile devices or desktop computers can be provided to offer enhanced functionality or offline capabilities.

A data upload component 182 enables users to upload captured data from the image capture device 100 to the processing server 160 for analysis. The upload component implements secure file transfer protocols, provides progress indicators during upload operations, and validates uploaded files to ensure they conform to expected formats and specifications. For large file uploads such as high-resolution panoramic images or dense point cloud data, the upload component preferably implements chunked upload mechanisms that divide large files into smaller segments, enabling reliable upload over variable network connections and providing resume capability if uploads are interrupted.

A processing monitor 184 enables users to track the progress of data processing operations. The processing monitor 184 provides real-time or near-real-time status updates using technologies such as WebSockets for server-push notifications or API polling mechanisms for periodic status checks. The processing monitor displays progress indicators showing the current processing stage, estimated completion times, and alerts users to any processing errors or issues requiring attention. When vendor API queries are in progress, the monitor displays which vendors have responded and which queries are still pending.

A results viewer 186 presents the processed results to users in intuitive visual formats. The results viewer 186 displays the original photographic images with overlays indicating detected objects, bounding boxes, segmentation masks, classification labels, confidence scores, and measurements. Users can interactively explore the results, zooming into areas of interest, toggling different overlay types, and accessing detailed information about specific detected objects. The results viewer 186 also preferably presents the vendor pricing information retrieved through the API integration module 150 in organized tables or comparative visualizations, enabling users to review cost estimates and comparative pricing for repair or replacement of detected items. The interface clearly indicates which pricing information is current versus cached, and provides options to refresh pricing data from vendors when desired.

A report generator 188 creates comprehensive reports aggregating the analysis results. Reports preferably include property information, summary statistics of detected objects, detailed listings of all detected items with classifications, measurements, and confidence scores, thermal imaging analysis results with affected area boundaries, cost estimation summaries with itemized pricing breakdowns from vendor databases including vendor identification and comparative pricing, and visual documentation including annotated images. Reports can be generated in various formats including PDF for formal documentation and distribution, CSV for data analysis in spreadsheet applications, JSON for programmatic access and integration with other systems, and HTML for web-based viewing. Report templates can be customized based on user requirements, organizational branding, or industry-specific standards.

The performance of the machine learning components upon which the system's segmentation and detection capabilities depend is a function of the training methodology and model deployment practices employed.

The machine learning models utilized by the automated segmentation module 120 and object recognition module 130 require training on labeled datasets, preferably in COCO format comprising images with bounding box annotations and classification labels. Training involves iterative weight adjustment to minimize prediction errors, with configuration of hyperparameters including learning rate, batch size, and number of epochs. For property assessment applications, training datasets include diverse examples of architectural features, appliances, fixtures, room types, and damage patterns under various lighting conditions and viewpoints. The system implements adaptive active learning wherein cases with low model confidence are flagged for manual annotation and used to retrain models, enabling continuous improvement. Trained models are exported in formats such as PyTorch, ONNX, or Tensor® with version tracking to enable performance comparison and rollback capability.

Complementing the processing and API integration capabilities described above, the system implements comprehensive error handling and reliability mechanisms to ensure robust operation across a range of failure conditions.

Data validation using schema validation libraries ensures data type correctness, required field presence, and format compliance at upload, processing, and API response stages. Service recovery mechanisms including health check endpoints, automated restart procedures, and redundant instances with failover ensure service availability. Database systems implement regular full and incremental backups stored in geographically distributed locations with periodic integrity verification.

For vendor API integration, retry logic with exponential backoff addresses network errors, authentication failures trigger token refresh, rate limit responses trigger throttling and delayed retry, and timeout conditions result in cached data usage when available. Comprehensive logging captures all significant events including data uploads, processing operations, API calls, errors, and performance metrics for monitoring, troubleshooting, and trend analysis. Monitoring and alerting systems detect anomalies and notify administrators of conditions requiring attention. Software updates preferably use canary deployment wherein new versions are initially deployed to a subset of instances and carefully monitored before full deployment.

While described primarily for property assessment, the invention is readily adaptable to diverse industries. For example, in agricultural applications, object detection models can recognize crop types, identify diseased plants, detect pest infestations, and assess crop maturity, while thermal imaging identifies irrigation issues and crop stress. For disaster management following wildfires, floods, or earthquakes, the system enables rapid assessment of damage extent through automated detection of damaged structures, infrastructure failures, and debris accumulation, with vendor API integration providing emergency service and reconstruction pricing. For construction and infrastructure monitoring, periodic assessments identify structural deterioration, detect defects, and monitor change over time, with measurement comparison across assessment cycles quantifying settlement, deflection, or degradation rates.

The system architecture supports customization through configuration parameters, trained model selection, and modular component replacement to adapt the system to specific industry requirements while maintaining the core technical innovations of the invention.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. Thus, it should be understood, therefore, that the invention may be practiced otherwise than as specifically set forth herein.

1. A system for automated analysis of affected areas, comprising:
an image capture device comprising an integrated Lidar sensor and photographic camera configured to substantially simultaneously capture photographic images and three-dimensional point cloud data of an area of interest;
an automated segmentation module comprising a machine learning-based segmentation processor configured to process the photographic images to identify regions of interest and automatically extract segmented image portions therefrom;
an object recognition module comprising a real-time object detection processor configured to analyze the segmented image portions to detect and classify objects within the identified regions of interest;
a spatial measurement module configured to integrate the three-dimensional point cloud data with the detected objects to compute spatial measurements comprising at least one of dimensions, areas, and volumes;
an API integration module comprising:
an API connection manager configured to establish and maintain persistent communication channels with one or more external vendor database systems via network API endpoints,
an authentication handler configured to manage security credentials using at least one of JSON Web Tokens, API keys, and OAuth protocols,
a pricing query engine configured to automatically formulate and transmit API requests including object type and dimension parameters derived from the detected objects to retrieve current pricing information from the vendor database systems,
a response aggregator configured to receive and aggregate pricing responses from multiple vendor systems and generate comparative pricing information, and
a cache manager configured to cache vendor pricing responses with configurable expiration policies; and
an output module configured to provide object detection results, spatial measurements, and vendor pricing information.

2. The system of claim 1, further comprising a thermal imaging module configured to capture temperature data substantially simultaneously with the photographic images and automatically generate affected area boundaries based on temperature anomalies exceeding predefined thresholds.

3. The system of claim 2, wherein the thermal imaging module is configured to automatically generate the affected area boundaries based on temperature threshold analysis, and wherein the API integration module queries the vendor database systems for remediation pricing based on the thermal-defined affected areas.

4. The system of claim 1, wherein the automated segmentation module implements a promptable segmentation model configured to perform zero-shot segmentation of diverse objects without task-specific training, wherein the model identifies and extracts multiple discrete regions from wide field-of-view images without explicit prompts.

5. The system of claim 1, wherein the object recognition module implements a YOLO-family object detection model configured to process each segmented image portion in approximately 1-5 seconds.

6. The system of claim 1, wherein the spatial measurement module is configured to compute area measurements with accuracy of approximately ±0.5 inches and fixed point measurements with accuracy of approximately ±1 inch.

7. The system of claim 1, wherein the API integration module is configured to:
formulate vendor API requests dynamically based on real-time object detection results without relying on pre-stored cost data,
implement failover mechanisms to handle vendor API unavailability, and
aggregate pricing data from at least two different vendor systems to generate comparative cost information.

8. The system of claim 1, further comprising a queue-based processing architecture comprising an input queue configured to buffer incoming data and processing requests, multiple worker processes configured to retrieve and process items from the input queue concurrently, and an output aggregator configured to assemble processed results.

9. The system of claim 1, wherein the Lidar sensor is configured to capture point cloud data in at least one of LAS and LAZ formats, and the spatial measurement module comprises a depth mapping component configured to assign depth values from the point cloud data to corresponding pixels in the photographic images.

10. The system of claim 1, wherein the photographic camera is configured to capture 360-degree panoramic images, and the automated segmentation module is configured to extract multiple discrete segmented image portions from each panoramic image.

11. The system of claim 1, wherein the Lidar sensor has a minimum accuracy of approximately ±1 inch and a field of view of at least 350 degrees.

12. A method for automated analysis of affected areas, comprising:
capturing, using an image capture device comprising an integrated Lidar sensor and photographic camera, photographic images and three-dimensional point cloud data of an area of interest;
processing the photographic images with a machine learning-based segmentation model to identify regions of interest and extract segmented image portions, thereby reducing computational requirements for subsequent object detection;
analyzing the segmented image portions with a real-time object detection model to detect and classify objects within the segmented image portions;
integrating the three-dimensional point cloud data with the detected objects to compute spatial measurements;
automatically querying one or more external vendor database systems by:
establishing authenticated API connections using security credentials comprising at least one of JSON Web Tokens, API keys, and OAuth protocols,
formulating API requests including object type, dimensions, and quantity parameters derived from the detected objects and spatial measurements,
transmitting the API requests to the vendor database systems,
receiving current pricing responses from the vendor database systems, and
implementing caching of received pricing information to reduce API call volume;
aggregating pricing information retrieved from multiple vendor systems; and
providing object detection results, spatial measurements, and vendor pricing information.

13. The method of claim 12, further comprising capturing thermal imaging data substantially simultaneously with the photographic images and automatically generating affected area boundaries based on temperature anomalies.

14. The method of claim 12, wherein processing the photographic images comprises applying a promptable segmentation model to perform zero-shot segmentation of diverse objects without task-specific training.

15. The method of claim 12, wherein the photographic images comprise 360-degree panoramic images, and extracting segmented image portions comprises automatically extracting multiple discrete regions of interest from each panoramic image.

16. The method of claim 12, wherein integrating the three-dimensional point cloud data comprises:
loading point cloud data in at least one of LAS and LAZ formats;
aligning coordinate systems of the point cloud data and photographic images;
assigning depth values from the point cloud to corresponding pixels in the photographic images; and
computing spatial measurements for detected objects based on the assigned depth values.

17. The method of claim 12, wherein formulating API requests comprises implementing rate limiting to comply with vendor API usage restrictions, and wherein the method further comprises utilizing cached pricing data when rate limits are approached.

18. The method of claim 12, further comprising implementing a queue-based processing architecture comprising:
receiving incoming data uploads and processing requests into an input queue;
distributing processing tasks across multiple worker processes operating concurrently; and
dynamically scaling the number of active worker processes based on queue depth.

19. The method of claim 12, further comprising training object detection models using:
labeled training datasets in COCO format comprising bounding boxes and classification labels;
configuring training hyperparameters including learning rate, batch size, and number of epochs; and
implementing adaptive active learning by identifying low-confidence predictions, obtaining manual annotations for identified cases, and retraining models with expanded datasets.

20. A system for real-time multi-stream processing of affected area data, comprising:
a queue service configured to receive and buffer incoming data streams from multiple concurrent sources;
a plurality of worker processes configured to poll the queue service and asynchronously process data items retrieved from the queue;
a segmentation processor configured to process photographic images using a machine learning-based segmentation model to extract regions of interest;
an object detection processor configured to analyze extracted regions using a real-time object detection model;
a spatial measurement processor configured to integrate Lidar point cloud data with detected objects to generate three-dimensional measurements; and
an API interface configured to establish concurrent connections to multiple external vendor database systems via authenticated API endpoints and retrieve pricing information in parallel, wherein the API interface comprises:
an authentication handler configured to manage vendor API credentials,
a pricing query engine configured to generate vendor-specific API requests based on detected object parameters, and
a response aggregator configured to compile pricing data from multiple concurrent vendor API connections.

21. The system of claim 20, wherein the queue service implements message persistence and acknowledgement mechanisms to ensure processing reliability, and wherein failed processing tasks are automatically requeued for retry.

22. The system of claim 20, further comprising a load balancer configured to distribute incoming data streams across multiple processing server instances, enabling horizontal scaling to accommodate increased data volumes.

23. The system of claim 20, further comprising a processing monitor configured to provide real-time status updates to users regarding processing progress.
